(19) United States
(12) Patent Application Publication
(10) Pub. No.: US 2022/0027438 A1
(43) Pub. Date: Jan. 27, 2022

(54) DETERMINING WHETHER RECEIVED DATA IS REQUIRED BY AN ANALYTIC

(71) Applicant: Hewlett-Packard Development Company, L.P., Spring, TX (US)

(72) Inventors: Daniel Ellam, Bristol (GB); Jonathan Griffin, Bristol (GB)

(73) Assignee: Hewlett-Packard Development Company, L.P., Spring, TX (US)

(21) Appl. No.: 17/296,390

(22) PCT Filed: Apr. 4, 2019
(86) PCT No.: PCT/US2019/025733

§ 371 Date: May 24, 2021

(51) Int. Cl. G06F 17/40; G06F 21/56; G06F 21/55

(52) U.S. Cl. CPC G06F 17/40; G06F 21/552; G06F 21/56

(57) ABSTRACT

A non-transitory machine-readable storage medium encoded with instructions executable with a processor is described. The instructions comprise instructions to determine whether a received data item is required by an analytic process to make a determination; and instructions to, in response to determining that the received data item is required by the analytic process, store the received data item in a pre-analytic store.

### BACKGROUND

Analytics, for example machine learning systems, make determinations based on collected data. In some systems, the compute unit executing the analytic may be remotely located from the device collecting the data.

For example, a network security system may detect malicious network activity at a network edge device by making a determination based on collected network events, such as HTTP requests. The network security system may be remotely located from the edge devices on a server device.

### BRIEF DESCRIPTION OF THE DRAWINGS

FIG. 1 is a block diagram of an example computing environment in which examples of the present disclosure may operate.

FIG. 2 is a block diagram of an example computing system of the present disclosure

FIG. 3 is a flowchart of an example method of the present disclosure.

FIG. 4 is a flowchart of an example method of the present disclosure.

FIG. 5 is a diagram illustrating an example pre-analytic store.

FIG. 6 is a diagram illustrating an example metadata store.

### DETAILED DESCRIPTION

Analytic processes may require a certain minimum amount of data items in order to make determinations below a desired error rate, or at a level of performance that meets other predetermined metrics such as accuracy, precision, recall or f-score. Similarly, there may be a need for the data to fulfil other conditions, such as being collected over a sufficiently large sample time, or meeting certain quality criteria to avoid making determinations based on noisy data. However, analytic processes may no longer show any substantial improvement in the level of performance of their determinations once a sufficient number of data items have been collected. In such a case, the collection of further data items results in unnecessary storage.

In examples, a system, method or the instructions of a non-transitory machine-readable storage medium determines whether a received data item is required by an analytic in order to make a determination. For example, the received data item may not be required if the data items already collected meet a first criterion, or a plurality of first criteria, the first criteria being indicative of the fact that addition of the received data item will not substantially improve the accuracy of the determination. In some examples, if it determined that the received data item is not required, the data item is not stored for future processing by the analytic, and may be deleted.

In some examples, the system, method or instructions relate to the detection of malicious activity occurring periodically in a computer network. Accordingly, the data items referred to herein may represent network events, e.g. HTTP requests, which are processed by a network security analytic in order to detect malicious activity.

In further examples, the system, method or instructions determines whether the stored data items meet a second set of criteria, the second criteria indicating that the stored data items allow the network security analytic to make a determination. The second criteria may specify a minimum number of data items and/or a minimum sample timeframe. If the data items meet the second criteria, the data items are submitted for processing by the analytic. Accordingly, data is not submitted to the analytic that is insufficient to allow an accurate determination to be made.

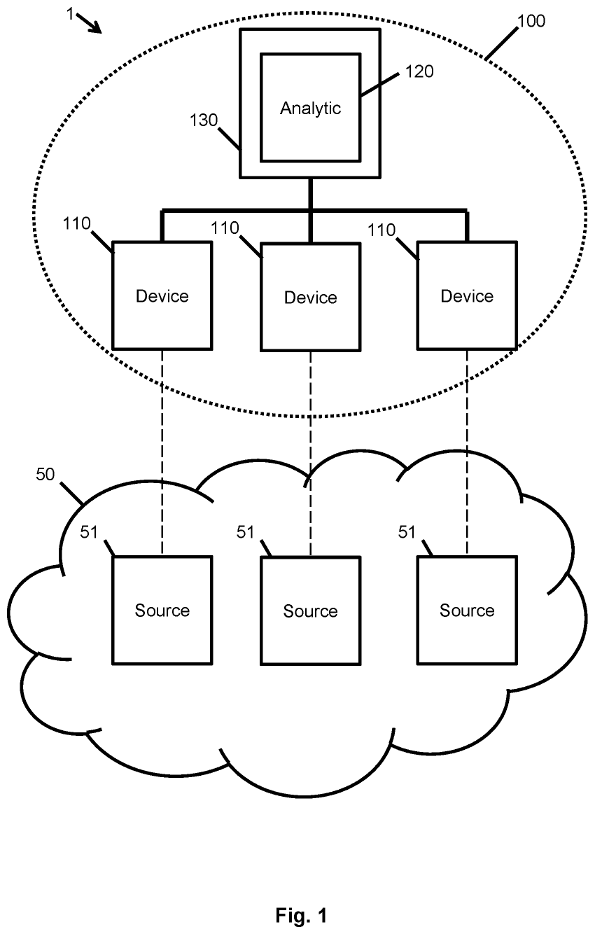

FIG. 1 shows an example computing environment 1 in which examples of the present disclosure operate.

The computing environment 1 comprises a computer network 100. The network 100 comprises a plurality of edge devices 110 and a network security analytic 120. The edge devices 110 form the boundary between the network 100 and an external computer network 50. Accordingly, the edge devices 110 comprise suitable networking hardware, for example a network interface. The external computer network 50 may for example be the Internet, another Wide Area Network or a Local Area Network. The edge devices 110 may be any suitable computing devices, including desktop computers, laptop computers, tablet computers, smart phones or other smart devices.

The network security analytic 120 is configured to detect suspicious network activity between an edge device 110 and a source 51, for example within the external network 50. The network security analytic 120 may be hosted remotely from the edge devices 110, for example on a server device 130. It will however be understood that in further examples the analytic 120 may be executed on one of the edge devices 110. In further examples, the execution of the analytic 120 is distributed across a plurality of devices. In other examples, the network security analytic 120 may be executed on a device that does not form part of the network 100 and could instead for example be hosted on an external server such as a cloud server.

In other examples, the source may be a source within the network 100, rather than a source 51 in the external network 50. Particularly, the network security analytic may be arranged to detect suspicious network activity between devices within the network 100. For example, such suspicious activity may occur between devices within the network if a device within the network has been compromised and therefore acts as a relay between the devices within the network 100 and an external device.

In one example, the network security analytic 120 receives data items as input, wherein the data items each represent a network event.

The network event may be a connection between one of the edge devices 110 and a source 51 within the external network 50. The network event may be any suitable communication made over a suitable network communication protocol, such as Hypertext Transfer Protocol (HTTP), HTTP Secure (HTTPS), File Transfer Protocol (FTP), the Domain Name System (DNS) or any other network protocol. For example, the communication may be a HTTP request, such as a HTTP GET request.

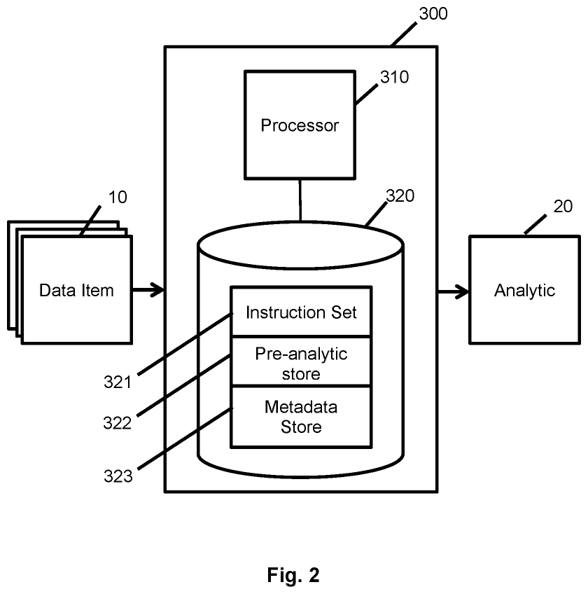

FIG. 2 shows an example computing system 300. The computing system 300 is configured to receive data items 10, and submit data items to an analytic 20. The computing system may for example be an edge device 110, and/or the analytic 20 may be the security analytic 120.

The computing system 300 comprises a processor 310 and a storage 320.

The processor 310 may take the form of any relevant compute element or combination of compute elements, including for example one or more of: a central processing unit (CPU), a graphics processing unit (GPU) or a field-programmable gate array (FPGA).

The storage 320 may take the form of any suitable computer-readable storage medium, and is configured to store any data required, either temporarily or permanently, for the operation of the system. The storage 320 may comprise volatile memory, for example random-access memory (RAM), and/or non-volatile memory such as Electrically Erasable Programmable Read-Only Memory (EEPROM). The storage 320 may include flash memory, magnetic discs, optical discs and the like.

The storage 320 is configured to store an instruction set 321, which may comprise instructions to carry out any of the methods described herein. The storage 320 comprises a pre-analytic store 322, which is configured to store data items 10 for processing by the analytic 20. Particularly, the pre-analytic store 322 is a data store, in which data items are stored before subsequent submission to the analytic 20.

In some examples, the storage 320 is also configured to store a metadata store 323.

In one example, the pre-analytic store 322 and/or metadata store 323 take the form of databases, for example relational databases, though it will be understood that other suitable data structures, including non-relational databases may be employed.

The instruction set 321 co-operates with the processor 310 and storage 320 in order to determine whether a received data item 10 is required by the analytic 20 in order for the analytic 20 to make a determination.

In one example, the determination regarding whether a received data item 10 is required by the analytic is made by determining whether the data items 10 already received and stored in the pre-analytic store 322 meet a first criterion. If the first criterion is met, it can be determined that the data items already stored in the pre-analytic store 322 are already sufficient to enable the analytic 20 to make an accurate decision or determination. Accordingly, the received data item 10 need not be submitted to the analytic 20.

In some examples, when it is determined that the received data item 10 is not required, the received data item 10 is deleted. For example, the received data item 10 may be stored in non-volatile memory or volatile memory whilst the determination is made. Subsequently, when it is determined that the received data item 10 is not required, the received data item 10 is then deleted from the non-volatile memory or volatile memory. In other examples, the received data item 10 need not be actively deleted. For example, the received data item is stored in volatile memory (e.g. RAM), and simply overwritten in due course. This may assist in avoiding the unnecessary collection of data, thus reducing data storage and transmission.

In one example, the first criterion specifies a maximum number of data items stored in the pre-analytic store 322. Accordingly, if the maximum number of data items have already been collected and are stored in the pre-analytic store 322, further data items can be discarded. In one example, the first criterion specifies a maximum required timeframe over which the data items must have been received. Once data items have been collected spanning the maximum required timeframe, any later data items received can be discarded. Accordingly, the first criterion can be used to determine that a sufficient number of data items 10 have been collected, or that data items have been collected over a suitable timeframe, such that the analytic can make a determination without requiring the collection of further data items 10.

A plurality of first criteria may be combined. In one example, the first criteria are combined using an AND operator. Accordingly, all of the first criteria must be satisfied in order for the system 300 to determine that the data item is not required. In one example, the first criteria are combined using an OR operator. Accordingly, only one of the first criteria must be satisfied in order for the system 300 to determine that the data item is not required. In further examples, both AND and OR operators may be employed to combine multiple criteria.

In one example, the metadata store 323 comprises metadata based on the data items stored in the pre-analytic store 322. For example, the metadata store 323 stores summary data, such as the number of data items present in the pre-analytic store 322, and the time frame over which these data items were collected. Accordingly, the determination regarding whether a received data item 10 is required by the analytic can be made based on the metadata stored in the metadata store 323. It will be appreciated, however, that in further examples the metadata store 323 may be omitted and the determination is carried out by directly analysing the data items in the pre-analytic data store.

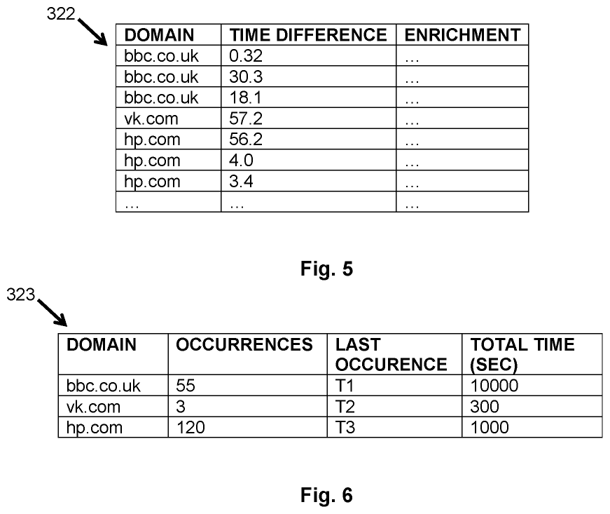

Examples of the pre-analytic store 322 and metadata store 323 are shown in FIGS. 5 and 6, respectively. The extract of the pre-analytic store 322 shown in FIG. 5 takes the form of a database table, wherein each row of the table represents a received data item 10. The domain column records the domain to which the data item relates. The time difference column records the time difference between the receipt of a data item and previous data item of that domain. The enrichment column includes any further data extracted from the network event that may be used by the analytic 20 to make a decision. The metadata store 323 includes summary data for each of the domains shown in the pre-analytic store 322. In particular, the occurrences column records the number of data items in the pre-analytic store 322 corresponding to that domain. The last occurrence column records the timestamp of the most recent occurrence of that domain. The total time column records the number of seconds between the earliest and latest occurrence of that domain.

For example, in the case of detecting suspicious network activity, it may be the case that it is known that only 100 observations spread out over 8 hours provides sufficient data for the analytic 20 to effectively detect the suspicious activity for a particular domain. Once both these two first criteria—i.e. the presence of at least 100 data items, and the time frame of at least 8 hours—are met, it can be determined that further data items do not need to be added to the pre-analytic store 322.

The metadata store 323 shows that neither of the first criteria are met for domain bbc.co.uk, because only 55 occurrences have been stored in the pre-analytic store 322 and the time frame of 10,000 seconds is less than 8 hours. Accordingly, a new data item 10 received for the domain bbc.co.uk would be added to the pre-analytic store 322.

If a data item 10 for hp.com were to arrive, the first criterion relating to the number of observations would be met because over 100 occurrences have are stored in the pre-analytic store 322. However, the first criterion relating to the time frame would not be met, because 1,000 seconds is less than 8 hours. As both criteria must be satisfied in this example in order to determine that further data items do not need to be added to the pre-analytic store 322, the data item for hp.com would be added to the pre-analytic store 322.

In one example, the analytic 20 comprises a machine learning model. The analytic 20 may for example be an unsupervised machine learning model, or a supervised machine learning model.

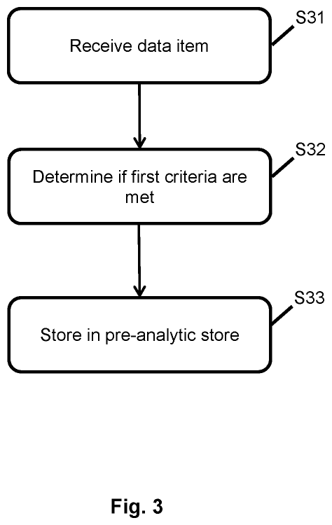

FIG. 3 illustrates an example method, which may be associated with determining whether a data item 10 is required by an analytic. In step S31, a data item 10 is received. For example, a network event or connection may occur between an edge device 110 and a source 210. The network event may be parsed to generate the data item 10. For example, the headers of the network event may be parsed to extract relevant information, such as the address of the source and the timestamp of the event.

In step S32, the method determines whether the first criteria are met. For example, the metadata store 323 may be queried to determine whether the data items 10 stored in the pre-analytic store 322 meet the criteria. For example, if the data item is a network event, the criteria indicate that the data items 10 stored in the pre-analytic store 322 are of a sufficient number and captured over a sufficiently long period in order to allow the analytic 20 to make a determination.

In one example, the first criteria may be applied to a particular category of data items 10 in the pre-analytic store 322. In the example of the data item 10 being a network event, the data items 10 may be categorised by domain. Accordingly, the first criteria can be used to determine whether sufficient data items 10 have been collected for a particular domain.

The first criteria may be predetermined. In other words, the first criteria are set in advance, for example by a domain expert. In particular, it is possible to analyse the error rate of the analytic based on the data items 10 submitted thereto. This may for example involve analysing a receiver operating characteristic (ROC) curve, the area under the ROC curve (AUC), and various other metrics for differing data sets. Accordingly, it can be determined when the collection of further data ceases to provide a substantially lower error rate, or alternatively, the volume and/or spread of data items 10 required to meet a predetermined minimum accuracy.

If it is determined that the first criteria are met, and thus the data item 10 is not required, the data item 10 is not stored in the pre-analytic store 322. The data item 10 may, for example, then be deleted.

If, in the alternative, it is determined that the first criteria are not met, and thus the data item 10 is required, the data item 10 is stored in the pre-analytic store in step S33. In one example, when a received data item 10 is stored in the pre-analytic store 322, the metadata store 323 is updated to reflect the addition of the new data item 10 to the pre-analytic store 322.

Subsequently, the data items stored in the pre-analytic store 322 are submitted to the analytic 20, such that the analytic can make a determination. In examples where the analytic 20 is remotely located from the pre-analytic store 322, the data items may be transmitted over a suitable network connection. In some examples, the data items are submitted in batch, or micro-batch to the analytic 20.

In some examples, once the data items are submitted, they are then deleted from the pre-analytic store 322. In the examples comprising a metadata store 323, the metadata store 323 is updated to reflect the deletion of the submitted data items from the pre-analytic store 322. Accordingly, the pre-analytic store 322 effectively acts as a buffer before submission to the analytic 20.

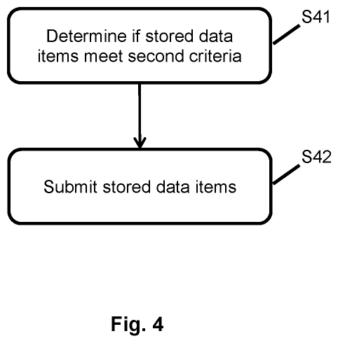

FIG. 4 illustrates another example method. In step S41, it is determined whether the data items 10 stored in the pre-analytic data store 322 meet a second criterion, the second criterion indicating that the stored data items allow the network security analytic to make a determination based on the stored data items. For example, the metadata store 323 may be queried to determine whether the data items stored in the pre-analytic store 322 meet the criterion.

In one example, the second criterion specifies a minimum number of data items stored in the pre-analytic store 322. In one example, the second criterion specifies a minimum timeframe over which the data items have been received.

A plurality of second criteria may be combined. In one example, the second criteria are combined using an AND operator. Accordingly, all of the second criteria must be satisfied in order for the system 300 to determine that that the stored data items allow the analytic to make a determination based on the stored data items. In one example, the second criteria are combined using an OR operator. Accordingly, only one of the second criteria must be satisfied in order for the system 300 to determine that the stored data items allow the analytic to make a determination based on the stored data items. In further examples, both AND and OR operators may be employed to combine multiple criteria.

The second criteria may be predetermined. In other words, the second criteria are set in advance, for example by a domain expert. As discussed above, it is possible to analyse the error rate of the analytic based on the data items submitted thereto. Accordingly, the minimum amount of data items, and/or the characteristics thereof, which enable a determination to be made by the analytic 20 at a predetermined minimum accuracy.

The second criteria may be applied to a particular category of data items in the pre-analytic store 322. In the example of the data item being a network event, the data items may be categorised by domain. Accordingly, the second criteria can be used to determine whether sufficient data items have been collected for a particular domain.

Returning to the examples of the pre-analytic store 322 and metadata store 323 shown in FIGS. 5 and 6, respectively, it may for example be the case that at least 10 observations of connections to the endpoint, and also need at least 2 hours of observed network activity to the endpoint allow the detection of suspicious network activity at or below the requisite error level. Accordingly, in this example there are two second criteria: the number of data items for that domain must be greater than or equal to 10, and the time frame must be at least 2 hours. The data items for the domain bbc.co.uk meet both second criteria, in that 55 occurrences is greater than equal to 10 occurrences, and in that 10,000 seconds is over 2 hours. However, the data items for the domain vk.com meet neither second criteria, and the data items for the domain hp.com do not meet the second criteria relating to the time frame.

In step S42, if it is determined that the data items meet the second criteria, the stored data items are submitted to the analytic 20. In some examples, once the data items 10 are submitted, they are then deleted from the pre-analytic store 322. In the examples comprising a metadata store 323, the metadata store 323 is updated to reflect the deletion of the submitted data items from the pre-analytic store 322.

As discussed above, the data items may be submitted in batch or micro-batch. Accordingly, the data items need not be submitted immediately upon the determination being made, but instead the data items may be included in the next scheduled batch.

Some of the examples described herein relate to the detection of periodic malicious network activity by a security analytic. However, it will be understood that the disclosure is not limited to this application. It will be appreciated that further examples may relate to differing analytics, for differing purposes. For example, the analytic 20 may be a fault detection analytic, configured to determine a fault in a sensor, such as an acoustic sensor. Similarly to as discussed above, first and optionally second criteria can be set in relation to the data items (e.g. sensor readings), so as to avoid collecting more data than necessary to determine a fault and optionally to avoid submitting too little data to an analytic to allow an accurate decision to be reached.

1. A computing system comprising:
a processor,
a storage coupled to the processor, the storage comprising a pre-analytic store to store a plurality of data items, each data item representing a network event, and
an instruction set to cooperate with the processor and the memory to:
determine whether a received data item is required by a network security analytic, by determining whether the data items stored in the pre-analytic store meet a first criterion;
in response to determining that the received data item is required by the network security analytic, store the received data item in the pre-analytic store.

2. The computing system of claim 1, wherein the instruction set is to cooperate with the processor and storage to delete the received data item in response to determining that the received data item is not required if it is not required by the network security analytic.

3. The computing system of claim 1, wherein the first criterion specifies a maximum number of data items required to allow the network security analytic to make a determination.

4. The computing system of claim 1, wherein the first criterion specifies a maximum required time frame over which the data items have been received.

5. The computing system of claim 1, wherein the network event is a HTTP request.

6. The computing system of claim 1, wherein:
the storage comprises a metadata store to store metadata based on the plurality of data items stored in the pre-analytic store, and
the instruction set is to cooperate with the processor and storage to determined whether the received data item is required based on the metadata stored in the metadata store.

7. The computing system of claim 1, wherein the instruction set is to cooperate with the processor and storage to:
determine whether the data items stored in the pre-analytic data store meet a second criterion, the second criterion indicating that the stored data items allow the network security analytic to make a determination based on the stored data items, and
in response, submit the stored data items for processing by the network security analytic.

8. The computing system of claim 7, wherein the second criterion specifies a minimum number of data items required in order for a determination to be made.

9. The computing system of claim 7, wherein the second criterion specifies a minimum time frame over which the data items have been collected.

10. A method comprising:
determining whether a received data item representing a network event is required by a network security analytic, by determining whether previously received data items already provide sufficient data for the network security analytic to make a determination below a predetermined error rate, and
in response to determining that the data item is required, storing the received data item for processing by the network security analytic.

11. The method of claim 10, wherein determining whether the received data item is required comprises determining whether the data items stored in the pre-analytic store meet a first criterion.

12. The method of claim 11, wherein the first criterion specifies a maximum number of data items required to allow the network security analytic to make a determination.

13. The method of claim 10, comprising:
determining whether the data items stored in the pre-analytic data store meet a second criterion, the second criterion indicating that the stored data items allow the network security analytic to make a determination based on the stored data items, and
submitting the stored data items for processing by the network security analytic.

14. A non-transitory machine-readable storage medium encoded with instructions executable with a processor, the machine-readable storage medium comprising:
instructions to determine whether a received data item is required by an analytic process to make a determination below a predetermined error rate;
instructions to, in response to determining that the received data item is required by the analytic process, store the received data item in a pre-analytic store.

15. The non-transitory machine-readable storage medium of claim 14, comprising:
instructions to determine whether the stored data items allow the analytic process to make a determination based on the stored data items, and
instructions to, in response, submit the stored data items for processing by the analytic process.
